(19) United States
(12) Patent Application Publication
(10) Pub. No.: US 2004/0211804 A1
(43) Pub. Date: Oct. 28, 2004

(54) Holding dock structure for a steel cable shackle of bicycles

(76) Inventor: Chian-Yi Lee, Taipei (TW)

Correspondence Address: BRUCE H. TROXELL, SUITE 1404, 5205 LEESBURG PIKE, FALLS CHURCH, VA, 22041, US

(21) Appl. No.: 10/421,895

(22) Filed: Apr. 24, 2003

(51) Int. Cl. B62J 7/00; B62J 9/00; B62J 11/00

(52) U.S. Cl. 224/427

(57) ABSTRACT

A novel holding dock structure for a steel cable shackle of bicycles and particularly to an improved holding dock structure to overcome the disadvantages of conventional steel cable shackle holding apparatus of bicycles that cannot accommodate different specifications of steel cables and result in riding interference caused by unstable holding and dangling of the steel cable shackles mainly includes an anchor dock which is extended to form a post clip with an opening to clamp a post of the bicycle frame. The post clip has side walls extended to form an arm which has an anchoring structure to receive and couple with a guiding arm extending from one end of a movable member. The movable member is slidable freely within the length of the guiding arm and moved in parallel with the arm of the anchor dock to clamp and anchor the steel cable shackle disposed therebetween so that the steel cable shackle is held securely without dropping or dangling. It can be adapted to accommodate a wide variety of sizes and specifications of steel cable shackles.

### BACKGROUND OF THE INVENTION

1. Field of the Invention

The invention relates to a novel structure for clamping and holding a bicycle steel cable shackle.

2. Description of the Prior Art

The apparatus for holding bicycle steel cable shackles are known in the art. For instance U.S. Pat. No. 4,966,382 granted on Oct. 30, 1990 discloses such a design. It includes a substantial U-shaped clip 50 with an opening at one end and a closed end which extends to form a clamp 30 to couple on a seat post 14 of a bicycle fame 11. The opening has one side pivotally coupling with a reflection lid 70. The bottom side of the reflection lid 70 has a jutting hook 80 to couple with a trap 82 extending from another side of the opening to close the U-shaped opening. When the hook and the trap 82 are disengaged, a shackle formed by a coiled steel cable may be clamped and held in the U-shaped clip 50. Then the hook 80 and the trap 82 may be coupled to close the opening to prevent the steel cable shackle from dropping. The structure mentioned above has problems in practical use, notably:

1. The U-shaped clip 50 that has an opening at one end forms a limited interior space which can hold only one specification of steel cable shackle. It cannot accommodate the steel cable of a larger size. On the other hand, if the steel cable is a smaller size, it cannot be held firmly and can only be held in a loose manner. And the steel cable shackle will dangle freely. The accessory also has to be formed in the same manner and also has the same kind of drawbacks. It is not a desirable design.

2. It provides only the function of holding the steel cable shackle, and cannot to couple with other elements or fastening members. Its functionality and added value is limited.

### SUMMARY OF THE INVENTION

In view of the aforesaid disadvantages, the invention aims at providing an improved design to overcome the problems mentioned above.

The primary object of the invention is to provide a holding dock structure for a steel cable shackle of bicycles that can accommodate and firmly secure various sizes and specifications of steel cable shackles of bicycles to provide an improved adaptability.

Another object of the invention is to provide a holding dock structure for a steel cable shackle of bicycles that can clamp the steel cable shackle to offer a secured holding without loosening off or dangling while the bicycle is moving so that an improved holding effect can be achieved.

Yet another object of the invention is to provide a holding dock structure for a steel cable shackle of bicycles that can be extended to couple with other elements or fastening members to expand the usefulness.

In order to achieve the foregoing objects, the invention mainly includes an anchor dock which is extended to form a post clip with an opening. The post clip may clamp the post of the bicycle. The post clip has an outer wall extending to form an arm. The juncture of the arm and the post clip has a guiding trough to receive an guiding arm extending from a movable member which may be moved relative to the arm. The guiding arm has one side forming a gear rack consisting of one-way ratchet teeth. The arm further pivotally houses a latch member which has a pointed claw corresponding to the one-way ratchet teeth. The latch member is pushed by an elastic element to press against the one-way ratchet teeth. The movable member is slidable within the length of the guiding arm and is harnessed by the latch member without escaping. The movable member and the arm of the anchor dock form a parallel clamping operation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a fragmentary perspective view of the guiding arm of the movable member of the invention.

FIG. 3 is a perspective view of the invention.

FIG. 4 is a schematic view of the turning knob in an operation condition.

FIG. 5 is a schematic view of the invention in a condition of clamping a steel cable shackle.

FIG. 6 is a perspective view of the invention extended to couple with a movable reflection dock.

FIG. 7 is a schematic view of the invention for adjusting the angle of a movable reflection dock.

FIG. 8 is a schematic view of the invention for coupling with other fastening members.

### DESCRIPTION OF THE PREFERRED EMBODIMENTS

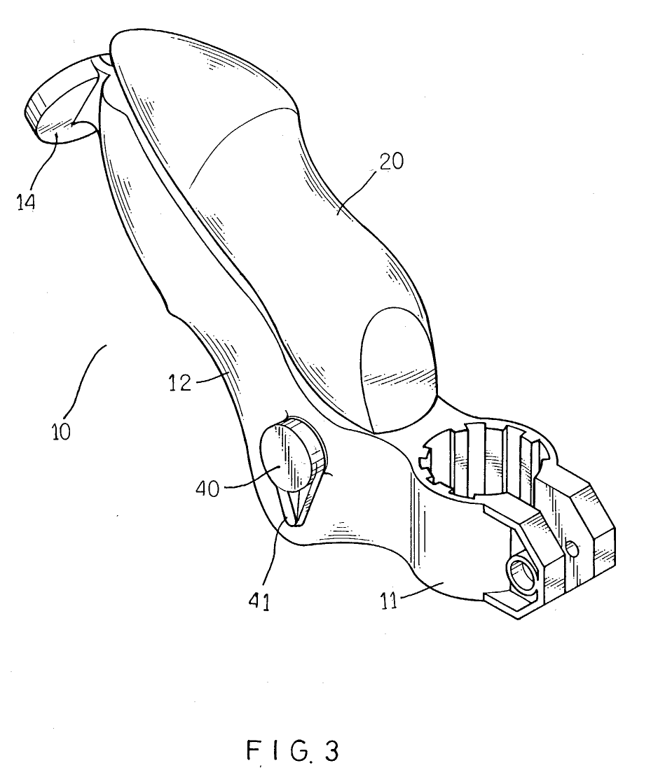

Referring to FIGS. 1 through 5, the invention mainly includes an anchor dock 10, a movable member 20, a latch member 30, a turning knob 40 and an elastic element 50.

The anchor dock 10 is extended to form a post clip 11 to clamp a post of the bicycle frame. The post clip 11 of the anchor dock 10 has side walls extending to form an arm 12 which is hollow and has an opening directly upwards. The surface of the side walls of the arm has jutting first clamp teeth 13 that are equally spaced. The arm has a distal end extending to form a reflection dock 14. The juncture of the arm 12 and the post clip 11 has a guiding trough 15.

The movable member 20 is an elongated hollow element mating the arm 12 of the anchor dock 10. It has two side walls bordering a downward opening and having equally spaced second clamp teeth 21 on the bottom side corresponding to the arm 12. The movable member 20 has one end extending downwards to form a guiding arm 22. The guiding arm 22 has an inner side surface forming a longitudinal gear rack with one-way ratchet teeth 23.

The latch member 30 has one end forming a pointed claw 31 with an anchor stub 32 located on one side thereof and another end forming a turning sleeve 33 with a square hole 34 forming therein.

The turning knob 50 has a round head extending sideward to form an driving handle 41 and a turning shaft 42 of a square cross section extending from the bottom of the head.

The elastic element 50 has an elastic force pushing the latch member 30.

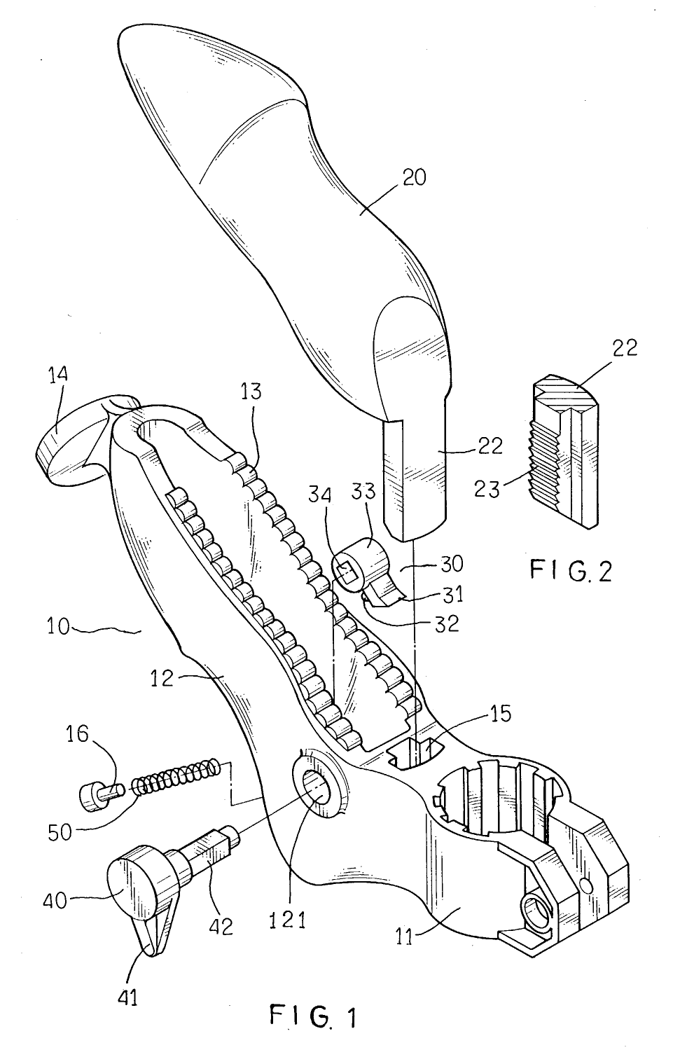

For assembling the invention, first, dispose the latch member 30 in the hollow interior of anchor dock 10 behind the guiding trough 15 of the arm 12; next, insert the square shaft 42 of the turning knob 40 through an aperture 121 formed on one side of arm 12 adjacent to the guiding trough 15 to engage with the square hole 34 of the turning sleeve 33 of the latch member 30; the arm 12 has an outer wall with a fastening hole 122 formed thereon to hold an anchor strut 16 which may hold the elastic element 50 such that another end of the elastic element 50 is coupled with the anchor stub 32 of the latch member 30; then insert the guiding arm 22 of the movable member 20 into the guiding trough 15 of the anchor dock 10 to finish the structure as shown in FIG. 2.

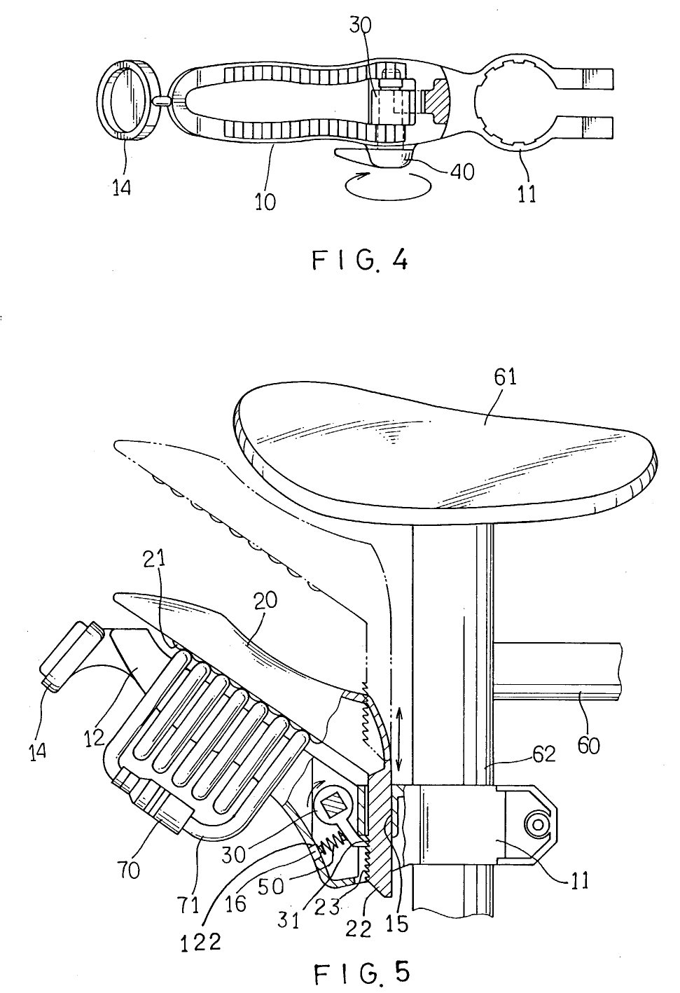

Refer to FIG. 5 for the cross section of the invention after assembled. The post clip 11 of the anchor dock 10 clamps an upright post 62 under the seat 61 of the bicycle frame 60. The guiding arm 22 of the movable member 20 is inserted into the guiding trough 15 with the inner surface of the one-way ratchet teeth 23 directing rearwards and facing the latch member 30. The pointed claw 31 of the latch member 30 is pushed by the elastic element 50 to press against the one-way ratchet teeth 23 so that the guiding arm 22 of the movable member 20 can be moved only in one way downward, but cannot be moved upwards or escape. When the cable 71 of a steel cable shackle 70 is hung on the arm 12 of the anchor dock 10, the movable member 20 may be moved downwards to couple with the arm 12 so that the steel cable shackle 70 is clamped and held securely without loosening off or dangling. As shown in FIGS. 4 and 5, the turning knob 40 located outside the arm 12 may be turned to drive the latch member 30, and the pointed claw 31 may be turned and moved away from the one-way ratchet teeth 23, then the movable member 20 may be released and moved upwards from the anchor dock 10 (shown by broken lines in the drawings), and the steel cable shackle 70 may be removed.

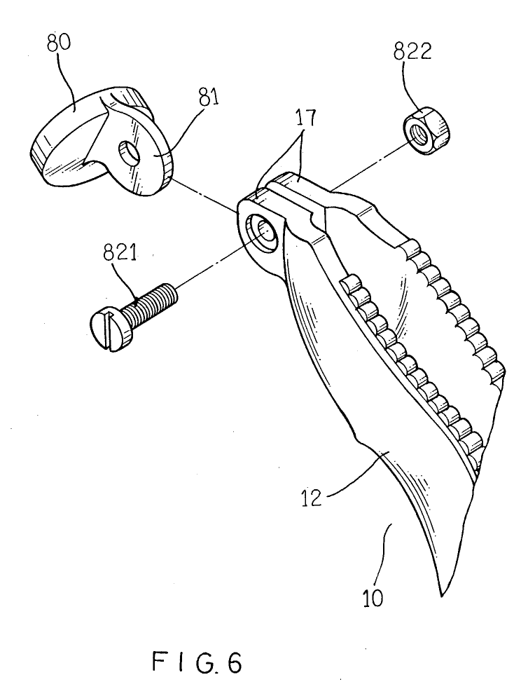

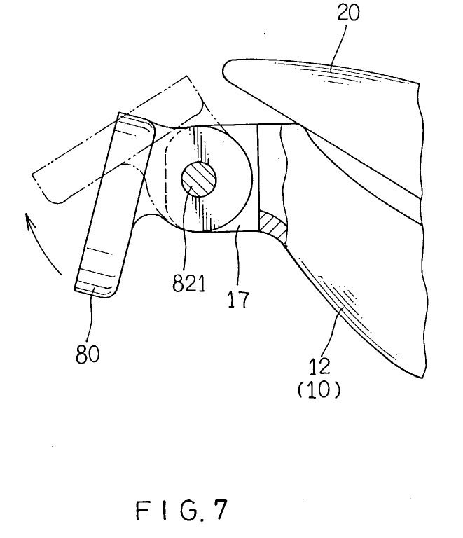

Refer to FIG. 6 for a second embodiment of the invention. The arm 12 of the anchor dock 10 has an outer end which is extended to form two clip flanges 17 for pivotally engaging with an anchor plate 81 of a reflection dock 80. A screw 821 may be coupled with a nut 822 for fastening. When there is a desire to adjust the angle of the reflection dock 80, turn the screw 821 and the nut 822 loose, then the reflection dock 80 may be turned about the screw 821 to adjust the angle as shown in FIG. 7.

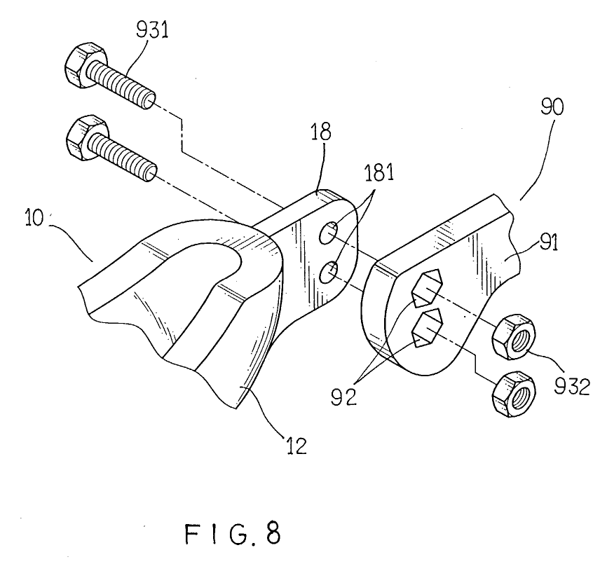

Refer to FIG. 8 for a third embodiment of the invention. The arm 12 of the anchor dock 10 has an outer end which is extended to form a clip flange 18 for pivotally engaging with other fastening member 90 of the bicycle. The fastening member 90 has a head 91 which has fastening holes 92 to engage with two screws 931 and nuts 932 for fastening. Thus it can couple with other fastening members of the bicycle.

By means of the construction set forth above, the holding dock structure of the invention can securely hold bicycle steel cable shackles of different sizes and specifications without dropping or dangling. The holding is more effective without affecting the balance of the bicycle. The anchor dock may also be extended to couple with other elements or fastening parts to provide additional functions.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A holding dock structure for a steel cable shackle of bicycles comprising an anchor dock and a movable member, the anchor dock being extended to form a post clip which has an opening for clamping a post of a bicycle frame, characterized in:
the post clip having a side wall extended to form an arm which has one end forming a guiding trough to receive an guiding arm extended from one end of the elongated movable member such that the movable arm is slidable freely within the length of the guiding arm and forms a parallel movement relative to the arm of the anchor dock to clamp and anchor the steel cable hackle disposed therebetween.

2. The holding dock structure of claim 1, wherein the guiding arm has a gear rack on an inner side surface forming one-way ratchet teeth, the arm pivotally housing a latch member which has a pointed claw corresponding to the ratchet teeth, the latch member being pushed by an elastic element to allow the pointed claw to press the ratchet teeth in one way.

3. The holding dock structure of claim 2, wherein the latch member has a root which forms a turning sleeve with a square hole to receive a turning shaft of a square cross section extending from a turning knob, the turning shaft running through the arm from outside to couple with the latch member and turn the latch member to release the guiding arm so that the movable member is allowed to be removed.

4. The holding dock structure of claim 1, wherein the elastic element has one end held by an anchor stub located on a back side of the latch member and another end held by an anchor strut engaged with a fastening hole located on a lower side of the arm such that the elastic element pushes the latch member in normal conditions to anchor the one-way ratchet teeth of the guiding arm through a lower end of the latch member.

5. The holding dock structure of claim 1, wherein the arm has a distal end extended to form two clip flanges to clamp a reflection dock.

6. The holding dock structure of claim 1, wherein the arm has a distal end extended to form a fastening flange which has two fastening holes for coupling with a head of a fastening member.
